(19) United States
(12) Patent Application Publication
(10) Pub. No.: US 2025/0024995 A1
(43) Pub. Date: Jan. 23, 2025

(54) OUTDOOR COOKING APPLIANCE TOOL

(71) Applicant: WH Products, LLC, Columbus, OH (US)

(72) Inventors: Alexandra Devi Upadhyaya, Louisville, KY (US); Paul J. Simon, Elizabethtown, KY (US)

(73) Assignee: WH Products, LLC, Columbus, OH (US)

(21) Appl. No.: 18/776,650

(22) Filed: Jul. 18, 2024

Related U.S. Application Data
(60) Provisional application No. 63/528,049, filed on Jul. 20, 2023.

(51) Int. Cl. A47J 37/07; A47J 37/06

(52) U.S. Cl. CPC A47J 37/0786; A47J 37/067; A47J 37/0704

(57) ABSTRACT

A cooking appliance tool removably mounted to a cooking appliance. The tool includes a horizontal handle with two opposing J-hooks extending downward from opposite ends of the handle. The J-hooks are configured to removably engage a cooking surface such as a griddle plate or grill grate.

### CROSS-REFERENCE TO RELATED APPLICATIONS

This application claims the benefit of U.S. Provisional Application No. 63/528,049 filed Jul. 20, 2023, entitled Outdoor Cooking Appliance Tool, the disclosure of which is hereby incorporated by reference herein in its entirety.

### FIELD OF THE INVENTION

Embodiments of the present invention relate to food cooking appliances.

### BACKGROUND OF THE INVENTION

Outdoor cooking, and particularly the use of outdoor barbecue grills, smokers, and griddles, remains very popular. A number of different appliances are currently available to cook food outdoors. All such appliances include a cooking surface to support food items, and historically the most popular outdoor primary cooking surfaces have been grill surfaces. A grill surface typically includes spaced metal elements, such as rods, that support food items above a heat source and permit juices and grease to fall through the spaces between the spaced elements. A grill surface permits flames from some types of heat sources to come in direct contact with food items imparting a particular “flame cooked” flavor. Flame cooking results in grease dripping directly on to heating elements, such as propane burners, which in turn results in unwanted flare ups that can scorch the food in a matter of seconds. Thus, while the ability to flame cook a food item is sometimes desirable, it comes at a cost in terms of temperature control, grease management, and safety, among others.

Indeed, while professional kitchens may include a grill cooking surface, such kitchens nearly universally include a griddle cooking surface. Thus, there is no doubt that griddle cooking is desirable. Griddle cooking surfaces referred to herein include any cooking surfaces having a relatively flat, continuous, heated, normally metal, surface for supporting food. The primary difference between griddle surfaces and grill surfaces is that the former do not include spaced elements that permit direct contact between food and a heat source, such as a propane burner. As a consequence, griddle surfaces also do not permit grease to drip through the cooking surface to the heat source giving griddle surfaces an advantage in terms of temperature control, grease management, and safety due to the absence of any risk of flare ups.

Given the respective advantages of grill and griddle cooking surfaces coupled with the increasing popularity of outdoor cooking, it is only natural that there is a need for well-designed and well-functioning outdoor grills and griddles. Well-functioning grills and griddles require periodic cleaning, and sometimes exchange between the two types of surfaces. Cleaning and exchange may require that the removal of the particular cooking surface from its position above the burners in the outdoor cooking appliance. Moreover, it may be difficult and undesirable to remove the cooking surface by hand as it may be heavy, slippery or greasy, dirty, and/or uncomfortably hot. Accordingly, there is a need for a method of removing an outdoor grill or griddle cooking surface from its cooking position. There is also a need for tools that facilitate the easy, safe and efficient removal of an outdoor grill or griddle cooking surface from its cooking position.

Both grills and griddles typically require the use of one or more accessories, including without limitation, substitute cooking surfaces, as well as tongs, spatulas, forks, and the like, to place, manipulate, and remove food items on or from the cooking surface. It is advantageous for the user to have easily accessible storage options for such accessories provided on the grill or griddle structure. Frequently storage options are provided in the form of one or more hooks provided on the grill or griddle which can be used to engage a flexible loop attached to a hand tool, for example, thereby allowing the hand tool to “hang,” at the cooking appliance ready for use. Such hooks may be fastened to the cooking appliance in a semi-permanent manner, such as with screws which do not facilitate easy and frequent removal. When fastened in a semi-permanent fashion the hooks cannot be easily removed for cleaning or to stay out of the way for placement of a cover over the cooking appliance. Indeed, semi-permanent hooks may interfere with cover placement causing damage and rips in the cover material. Conversely, cooking appliance accessory hooks may be S-shaped and “hooked” onto an opening provided in the cooking appliance. In such event, the hooks typically dangle loosely and may very easily and/or accidently become unhooked from the cooking appliance when lifting an accessory away from them. Accordingly, there is a need for cooking appliance accessory hook or hooks that can be easily removed for cleaning and appliance cover placement, but not so easily removed accidentally as a result of placing or removing an accessory onto or from the hooks.

In view of the foregoing, existing outdoor grills and griddles have need for both tools that facilitate the removal of a cooking surface and a system for storing cooking appliance accessories at the cooking appliance that can be easily removed, but not too easily removed. In order to minimize manufacturing cost, as well as reduce the clutter occurring from providing more storage hooks and cooking surface tools at the cooking appliance than are absolutely necessary, it would be advantageous to both the appliance designer and appliance user to provide a single tool system which could be used to remove cooking surfaces and store cooking appliance accessories. Accordingly, there is a need for a new tool system which can be used for these dual functions.

### OBJECTS OF THE INVENTION

Accordingly, it is an object of some, but not necessarily all embodiments of the present invention to provide methods and tools for removing an outdoor grill or griddle cooking surface from its cooking position.

It is also an object of some but not necessarily all embodiments of the present invention to provide a system incorporating cooking appliance accessory hooks that can be easily removed for cleaning and appliance cover placement, but not so easily removed accidentally as a result of placing or removing an accessory onto or from the hooks.

It is also an object of some but not necessarily all embodiments of the present invention to provide a single tool system which could be used to remove cooking surfaces and store cooking appliance accessories.

### SUMMARY OF EMBODIMENTS OF THE INVENTION

Responsive to the foregoing challenges, Applicant has developed an innovative outdoor cooking appliance, comprising: a head unit; a removable cooking surface having a first side and a second side disposed at opposite ends of the cooking surface; at least a first opening provided in the cooking surface at the first side; at least a second opening provided in the cooking surface at the second side; a first side table extending from the head unit; a second side table extending from the head unit; a first tool removably mounted to the first side table; a second tool removably mounted to the second side table, wherein each of said first tool and said second tool include: an upper handle configured to be grasped by a human being hand; a lower J-hook; and means for removably connecting to a side table, wherein the J-hook is configured to removably engage the at least first opening provided in the cooking surface and a cooking appliance accessory connection means.

Applicant has further developed an innovative cooking appliance tool configured to be removably mounted to a cooking appliance, said cooking appliance tool including: an upper handle configured to be grasped by a human being hand; a lower J-hook; and means for removably connecting to the cooking appliance tool to the cooking appliance, wherein the J-hook is configured to removably engage a cooking surface associated with the cooking appliance, and wherein the J-hook is configured to removably engage a cooking appliance accessory connection means.

Applicant has still further developed an innovative cooking appliance tool configured to be removably mounted to a cooking appliance, said cooking appliance tool including: an upper handle configured to be grasped by a human being hand; first and second lower J-hooks extending downward from opposite ends of the upper handle; and means for removably connecting to the cooking appliance tool to the cooking appliance, wherein the first and second J-hooks are configured to removably engage a cooking surface associated with the cooking appliance, and wherein the first and second J-hooks are configured to removably engage a cooking appliance accessory connection means.

Applicant has still further developed an innovative outdoor cooking appliance, comprising: a head unit; a removable cooking surface having a first side and a second side disposed at opposite ends of the cooking surface; at least a first opening provided in the cooking surface at the first side; at least a second opening provided in the cooking surface at the second side; a first side table extending from the head unit; a second side table extending from the head unit; a first tool removably mounted to the first side table; a second tool removably mounted to the second side table, wherein each of said first tool and said second tool include: an upper handle configured to be grasped by a human being hand; first and second lower J-hooks extending downward from opposite ends of the upper handle; and means for removably connecting to the cooking appliance tool to the cooking appliance, wherein the first and second J-hooks are configured to removably engage a cooking surface associated with the cooking appliance, and wherein the first and second J-hooks are configured to removably engage a cooking appliance accessory connection means.

Applicant has still further developed an innovative cooking appliance tool, comprising: an upper handle configured to be grasped by a human being hand between a handle first end and a handle second end; a first lower J-hook connected to the handle first end wherein an elongated straight portion of the first lower J-hook is proximal to the handle first end and a curved portion of the first lower J-hook is distal from the handle first end; a second lower J-hook connected to the handle second end wherein an elongated straight portion of the second lower J-hook is proximal to the handle second end and a curved portion of the second lower J-hook is distal from the handle second end; and means for removably connecting the cooking appliance tool to a cooking appliance, wherein the first lower J-hook and the second lower J-hook are configured to removably engage a removable cooking surface associated with the cooking appliance.

Applicant has still further developed an innovative outdoor cooking appliance, comprising: a head unit; a removable cooking surface having a first side and a second side disposed at opposite ends of the cooking surface; at least a first opening provided in the cooking surface at the first side; at least a second opening provided in the cooking surface at the second side; a first side table extending from the head unit; a second side table extending from the head unit; a first tool removably mounted to the first side table, said first tool including: a first handle configured to be grasped by a first human being hand; a first J-hook connected to the first handle; and means for removably connecting the first tool to the first side table; and a second tool removably mounted to the second side table including: a second handle configured to be grasped by a second human being hand; a second J-hook connected to the second handle; and means for removably connecting the second tool to the second side table, wherein the first J-hook is configured to removably engage the at least first opening provided in the cooking surface, and wherein the second J-hook is configured to removably engage the at least second opening provided in the cooking surface.

Applicant has still further developed an innovative cooking appliance tool and cooking surface set, comprising: a first hand tool including: a first upper handle configured to be grasped by a human being hand between a first handle first end and a first handle second end; a first lower J-hook connected to the first handle first end wherein an elongated straight portion of the first lower J-hook is proximal to the first handle first end and a curved portion of the first lower J-hook is distal from the first handle first end; a second lower J-hook connected to the first handle second end wherein an elongated straight portion of the second lower J-hook is proximal to the first handle second end and a curved portion of the second lower J-hook is distal from the first handle second end; and means for removably connecting the first hand tool to a cooking appliance; and a cooking surface including: a first cooking surface side distal from a second cooking surface side separated by a main surface configured to support food items; and two or more openings formed in the cooking surface at the first cooking surface side, said two or more openings each forming an engagement shoulder, wherein the first lower J-hook and the second lower J-hook are configured to removably engage the engagement shoulders of the two or more openings formed in the cooking surface at the first cooking surface side.

It is to be understood that both the foregoing general description and the following detailed description are exemplary and explanatory only and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only and should not be construed as limiting the invention.

FIG. 1 is a perspective view of the front of an outdoor cooking appliance in accordance with embodiments of the invention.

FIGS. 2 and 3 are detailed perspective views of an outdoor cooking appliance side table and a cooking appliance tool as used to store cooking appliance accessories in accordance with embodiments of the invention.

FIG. 4 is a perspective view of an outdoor cooking appliance side table with an attached cooking appliance tool in accordance with embodiments of the invention.

FIG. 5 is a perspective view of an outdoor cooking appliance side table with a detached cooking appliance tool in accordance with embodiments of the invention.

FIG. 6 is a perspective view of the front of a cooking appliance tool in accordance with embodiments of the invention.

FIG. 7 is a perspective view of the back of a cooking appliance tool in accordance with embodiments of the invention.

FIG. 8 is a perspective view of the front of an outdoor cooking appliance with a cooking surface elevated above the appliance by two cooking appliance tools in accordance with embodiments of the invention.

FIG. 9 is a perspective view of a cooking surface and two cooking appliance tools in a position before engagement of the cooking surface in accordance with embodiments of the invention.

FIG. 10 is a perspective view of a cooking surface and two cooking appliance tools in a position after engagement of the cooking surface in accordance with embodiments of the invention.

### DETAILED DESCRIPTION OF EMBODIMENTS OF THE INVENTION

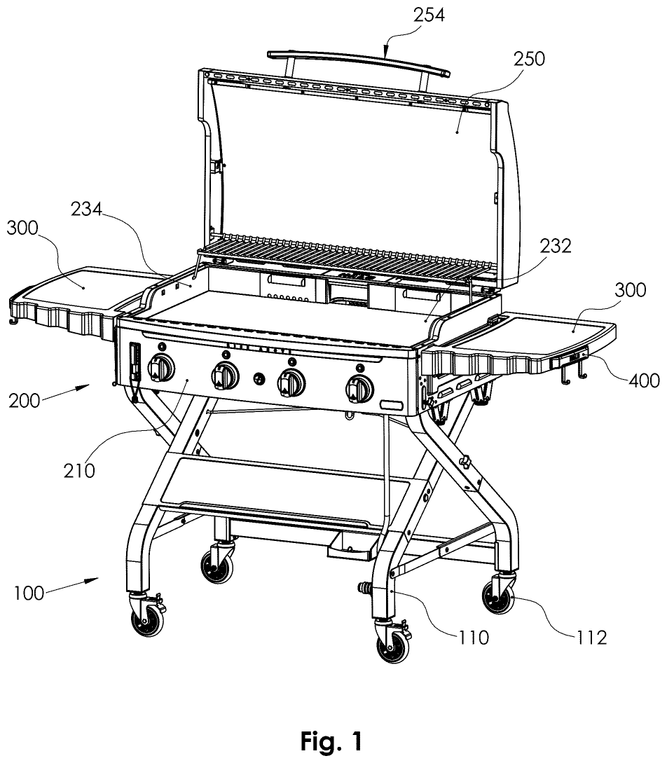

Reference will now be made in detail to embodiments of the present invention, examples of which are illustrated in the accompanying drawings. With reference to FIG. 1, an outdoor cooking appliance, such as a gas griddle, may include a lower cart 100 and an upper head unit 200. The cart 100 may include a plurality of cart legs 110 joined by a cart base with fashioners, such as screws, bolts, cotter pins, or the like. The cart legs 110 may be provided with caster wheels 112 and wheel locks. The leg tops may be removably connected to the head unit 200. The size, shape, and design of the cart 100 may be varied without departing from the intended scope of the invention. For example, in alternative embodiments, the cart may include an enclosed cabinet for storage and/or esthetic purposes.

The head unit 200 may include a cooking appliance body 210 having a left side wall, and a right side wall, respectively. Side tables 300 may be connected to the griddle body 210 along the left and right side walls by one or more brackets or other connectors (not shown). The side tables 300 may be spaced from the cooking appliance body 210 by one or more spacers, which may be formed by embossments or separate elements. The side tables 300 may be provided with one or more scalloped recesses with raised embossed interior surfaces. The embossments may be provided with flat magnets on their inner surfaces so as to provide magnetic tool holders.

The front of the head unit 200 may include a control panel having one or more control knobs. One or both sides of the cart 100 may include hardware used to hang and/or secure one or more propane gas tanks. A low profile lid 250 may form the top of the head unit 200 thereby selectively enclosing the cooking appliance body 210 to form a cooking chamber. The lid 250 may include a handle 254 and lid sides. The lid 250 may be connected to the rear wall of the cooking appliance body 210 by a hinge assemblies. The cooking appliance body 210 may also include a cooking surface 232 constructed of metal or other material. The cooking surface 232 may have one or more side walls 234 disposed at opposite ends of a back wall.

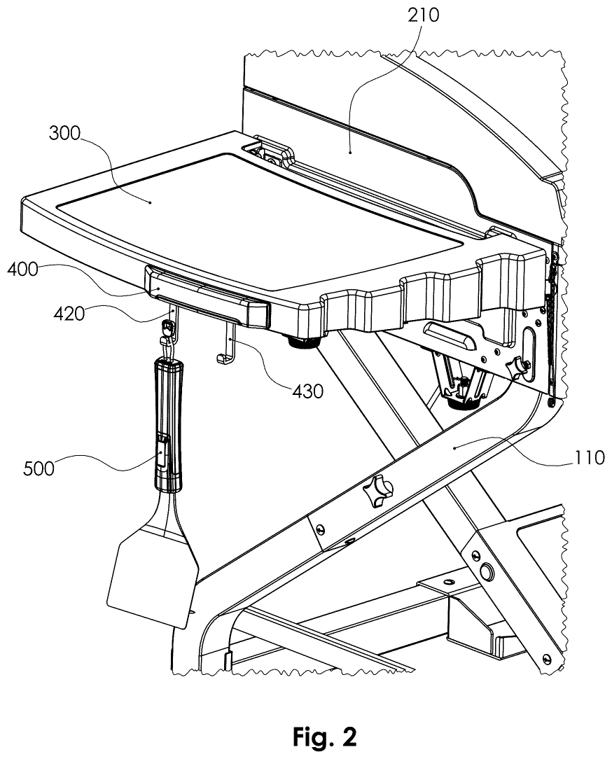

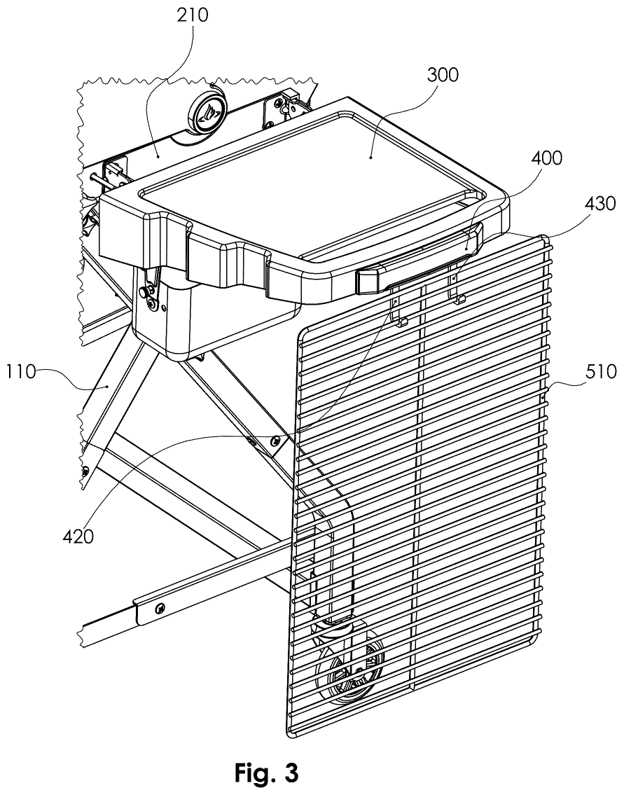

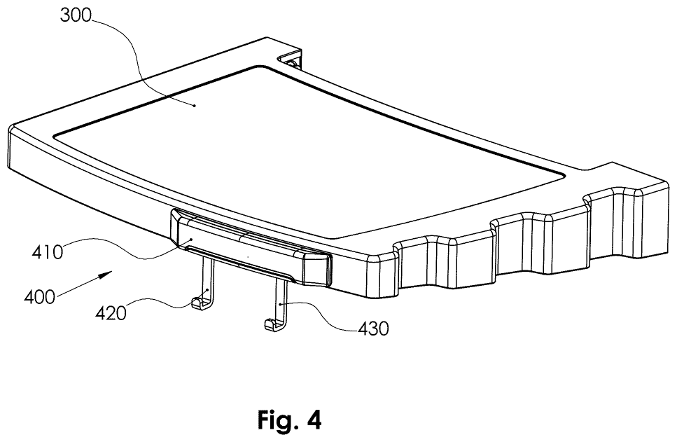

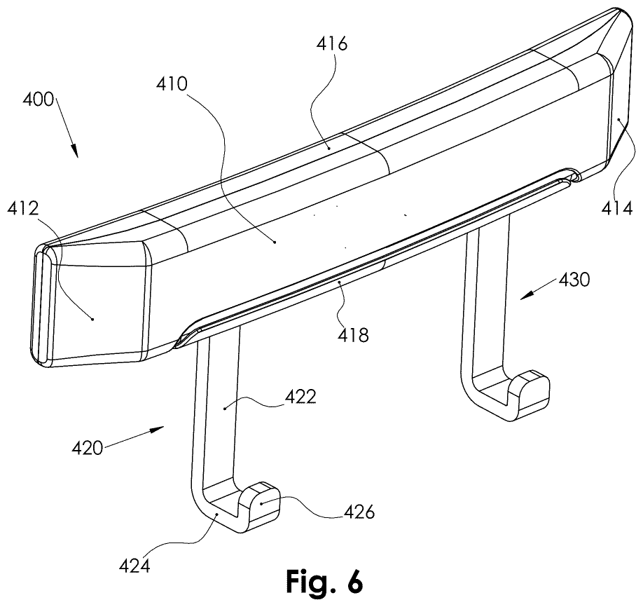

With reference to FIGS. 2-4, in which like reference characters refer to like elements, each of the side tables 300 may have an outer edge distal from the cooking appliance body 210. A cooking appliance tool 400 may be removably but securely mounted to each of the left and right side tables 300. Each cooking appliance tool 400 may include a cooking appliance tool handle 410 from which an identical pair of first and second J-hooks 420 and 430 extend downward. Each of the first and second J-hooks 420 and 430 may be configured to engage, support, and/or lift one or more cooking appliance accessories, such as a spatula 500 and a cooking grate 510, for example. With reference to FIG. 5, each of the side tables 300 may include a first notched opening 320 and a second notched opening 332. Each of the notched openings 330 and 332 may have a somewhat pear shape with the narrower portion of the shape below the wider portion of the shape. The notched openings 330 and 332 may be configured to securely engage first and second pins extending from the back of the cooking appliance tool 400 (shown in FIG. 7).

With reference to FIGS. 5 and 7, each of the connection pins 440 may include an outer head portion and an inner neck portion wherein the neck portion is narrower than the head portion. Each of the connection pins 440 may be configured such that the head portion may be received and pushed past the wider portion of a respective one of the pear shaped first and second notched openings 330 and 332. Once each of the connection pins 440 is fully inserted into a corresponding one of the first and second notched openings 330 and 332, the cooking appliance tool 400 may be pushed downward and/or sideward such that the neck portions of the connection pins 440 lodge securely in the narrower portions of the pear shaped first and second notched openings. As a result, the appliance cooking tool 400 may be securely, but removably, attached to the side table 300 outer edge under the influence of gravity because the head portions of the connection pins 440 are trapped behind the side table 300 outer edge, being unable to pass through the narrower portions of the first and second notched openings 330 and 332.

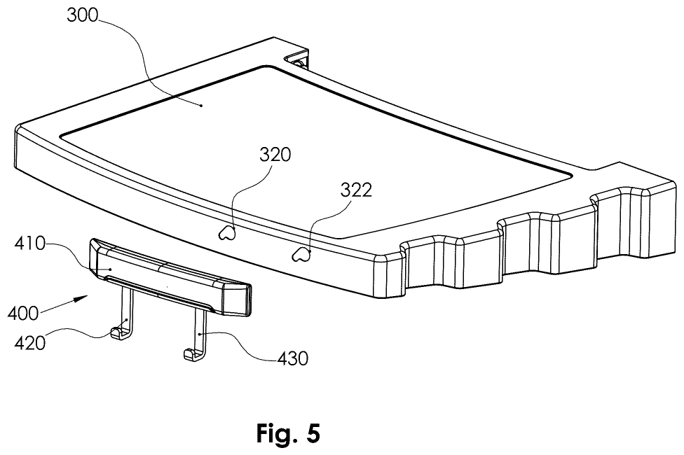

With reference to FIGS. 6 and 7, each cooking appliance tool 400 may include a first J-hook 420 and an essentially identical second J-hook 430 laterally spaced from each other. The space between the first J-hook 420 and the second J-hook 430 is preferably sufficient to permit an adult hand to fit therebetween in order to grasp the tool handle 410 comfortably. The first and second J-hooks 420 and 430 preferably may be constructed of formed flat stock metal. First J-hook 420, which is representative of both J-hooks, may include an elongated straight vertical section 422 extending downward out of the tool handle 410. The vertical section 422 of the first J-hook 420 may include an enlarged head or other connection element (e.g., hole in the J-hook, and mating peg provided by an internal portion of the connection pins 440) at its upper most end (not shown) which keeps the first J-hook locked into a static position relative to the tool handle 410. The shape of the first J-hook 420 may be completed by a lateral section 424 that extends at roughly a right angle away from the bottom end of the vertical section 422, and a tip 426 that extends at roughly a right angle upward from the lateral section. The J-hook 420 lateral section 424 and tip 426 essentially form a lower curved portion of the J-hook, and it is appreciated that the manner of creating the curved portion can vary between a smooth curve to right angled bends, as shown. The tool handle 410 preferably may include a first side sloped surface 412 and a second side sloped surface 414 that smoothly transition the between thick and thin portions of the tool handle. The first and second side sloped surfaces 412 and 414 may reduce the number and size of sharp edges on the tool handle 410 making it easier to handle and more esthetically pleasing. The tool handle 410 also may include an upper rounded surface 416 and a lower rounded surface 418 that smoothly transition the tool handle upper and lower horizontal surfaces to the intermediate vertical surface. The upper and lower rounded surfaces 416 and 418 may reduce the number and size of sharp edges on the tool handle 410 making it easier to handle and more esthetically pleasing. A back plate 460 may be fastened to the tool handle 410 using fasteners 450. The back plate 460 permits easy and efficient connection of the first and second J-hooks 420 and 430 to the tool handle 410. The back plate 460 may cover the internal portions of first and second connection pins 440. The connection pins 440 internal portions may form pegs that extend through the back plate towards the tool handle 410. The first and second pegs may be configured to receive mating openings formed in the upper ends of the upper elongated straight portions of the first and second J-hooks 420 and 430.

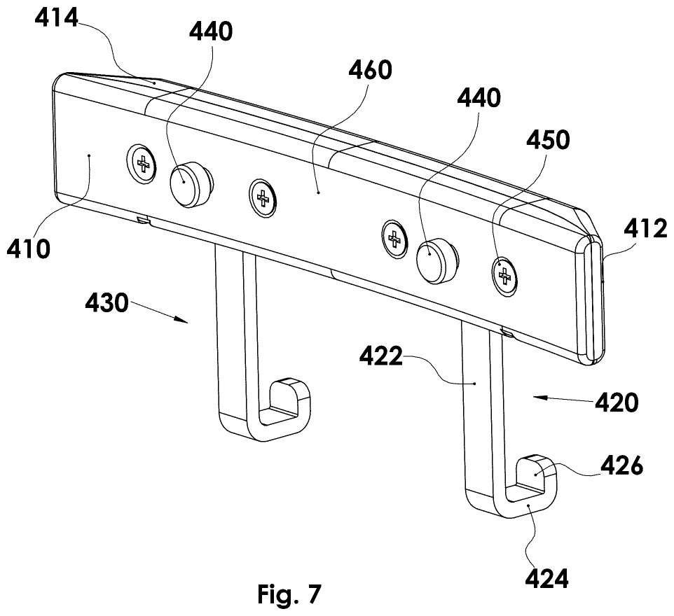

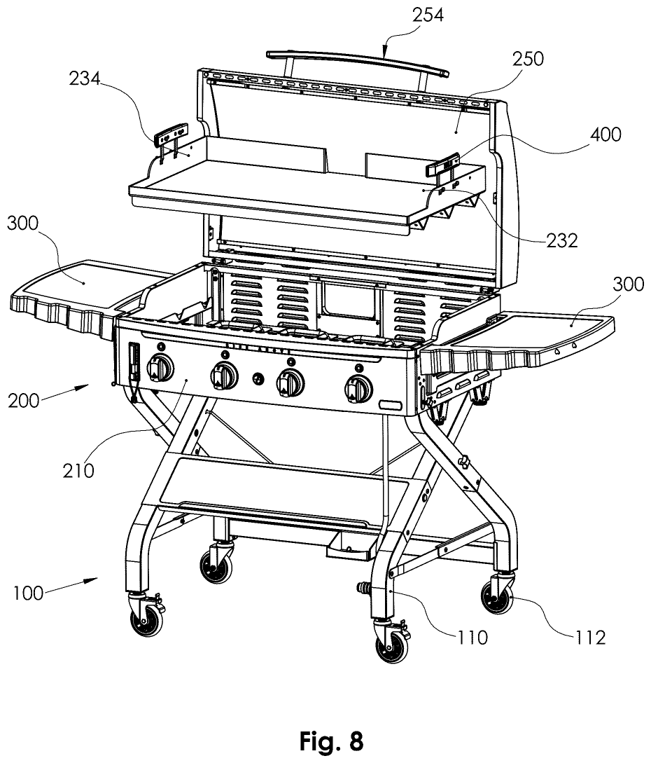

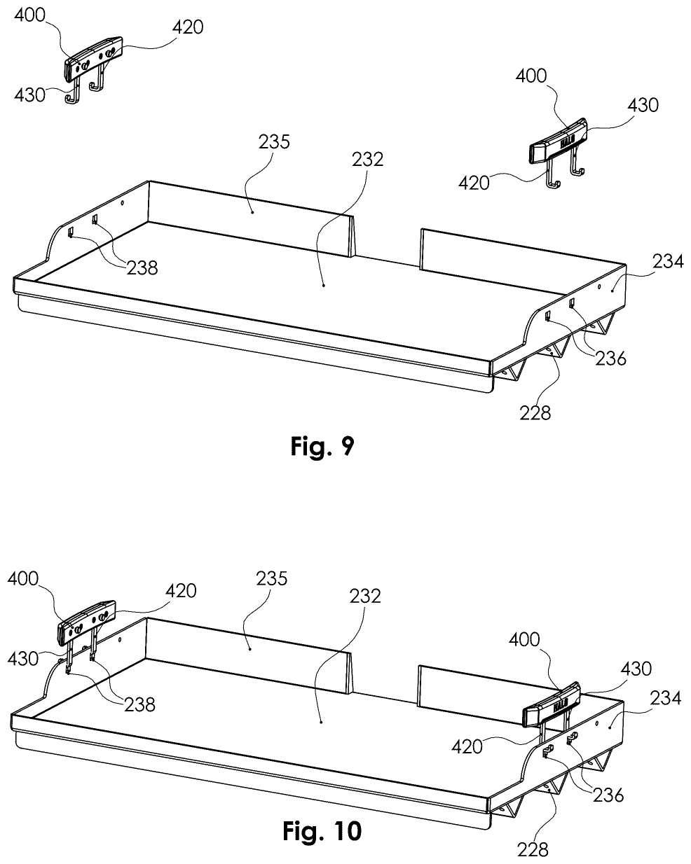

With reference to FIGS. 8-10, the cooking appliance tool 400 may be used to remove and otherwise manipulate a cooking surface 232, such as a griddle plate, as follows. The term “cooking surface” is intended to include the entire cooking surface body which may include vertical sides that extend upward from the boundary region of the surface on which food rests. The cooking appliance tools 400 attached to each of side tables 300 may be removed by a user lifting them up and away from each respective side table. The user may then insert the first and second J-hooks 420 and 430 of a first cooking appliance tool 400 into mating first side wall openings 236, and insert the first and second J-hooks 420 and 430 of a second cooking appliance tool 400 in mating second side wall openings 238. The J-hooks 420 and 430 engage shoulders formed by the first and second side wall openings 236 and 238. Thereafter, the user may use the pair of cooking appliance tools 400 to lift the griddle plate out of the cooking appliance body 210. Similarly, the J-hooks 420 and 430 may be used to engage the rods or cross bars of a cooking grate 510 (shown in FIG. 3).

As will be understood by those skilled in the art, the invention may be embodied in other specific forms without departing from the spirit or essential characteristics thereof. The elements described above are provided as illustrative examples for implementing the invention. One skilled in the art will recognize that many other implementations are possible without departing from the present invention as recited in the claims. Accordingly, the disclosure of the present invention is intended to be illustrative, but not limiting, of the scope of the invention. It is intended that the present invention cover all such modifications and variations of the invention, provided they come within the scope of the appended claims and their equivalents.

What we claim is:

1. A cooking appliance tool, comprising:
an upper handle configured to be grasped by a human being hand between a handle first end and a handle second end;
a first lower J-hook connected to the handle first end wherein an elongated straight portion of the first lower J-hook is proximal to the handle first end and a curved portion of the first lower J-hook is distal from the handle first end;
a second lower J-hook connected to the handle second end wherein an elongated straight portion of the second lower J-hook is proximal to the handle second end and a curved portion of the second lower J-hook is distal from the handle second end; and
means for removably connecting the cooking appliance tool to a cooking appliance,
wherein the first lower J-hook and the second lower J-hook are configured to removably engage a removable cooking surface associated with the cooking appliance.

2. The cooking appliance tool of claim 1, further comprising:
an appliance side table having an outer edge surface shape,
wherein the upper handle has a back surface shape that is complementary to, and mates with the appliance side table outer edge surface shape.

3. The cooking appliance tool of claim 2, wherein the upper handle has a height dimension extending between a lower edge and an upper edge that is no greater than a height dimension extending between a lower edge and an upper edge of the appliance side table outer edge surface.

4. The cooking appliance tool of claim 1, further comprising:
a back plate fastened to the upper handle, wherein the back plate covers an upper end of the first lower J-hook elongated straight portion, and the back plate covers an upper end of the second lower J-hook elongated straight portion.

5. The cooking appliance tool of claim 4, wherein the means for removably connecting the cooking appliance tool to a cooking appliance includes first and second spaced connection pins that each include an outer head portion and an inner neck portion wherein the neck portion is narrower than the head portion.

6. The cooking appliance tool of claim 5, wherein the connection pins include internal portions that form first and second pegs that extend through the back plate towards the tool handle, and
wherein the first and second pegs are configured to receive mating openings formed in the upper elongated straight portions of the first and second lower J-hooks.

7. The cooking appliance tool of claim 1, wherein the upper handle first end includes a first side sloped surface transitioning between an outer thin portion of the first end and an inner relatively thicker portion of the first end, and
wherein the upper handle second end includes a second side sloped surface transitioning between an outer thin portion of the second end and an inner relatively thicker portion of the second end.

8. A cooking appliance tool and cooking surface set, comprising:
a first hand tool including:
a first upper handle configured to be grasped by a human being hand between a first handle first end and a first handle second end;
a first lower J-hook connected to the first handle first end wherein an elongated straight portion of the first lower J-hook is proximal to the first handle first end and a curved portion of the first lower J-hook is distal from the first handle first end;
a second lower J-hook connected to the first handle second end wherein an elongated straight portion of the second lower J-hook is proximal to the first handle second end and a curved portion of the second lower J-hook is distal from the first handle second end; and
means for removably connecting the first hand tool to a cooking appliance; and
a cooking surface including:
a first cooking surface side distal from a second cooking surface side separated by a main surface configured to support food items; and
two or more openings formed in the cooking surface at the first cooking surface side, said two or more openings each forming an engagement shoulder,
wherein the first lower J-hook and the second lower J-hook are configured to removably engage the engagement shoulders of the two or more openings formed in the cooking surface at the first cooking surface side.

9. The cooking appliance tool and cooking surface set of claim 8 further comprising:
a second hand tool including:
a second upper handle configured to be grasped by a human being hand between a second handle first end and a second handle second end;
a third lower J-hook connected to the second handle first end wherein an elongated straight portion of the third lower J-hook is proximal to the second handle first end and a curved portion of the third lower J-hook is distal from the second handle first end;
a fourth lower J-hook connected to the second handle second end wherein an elongated straight portion of the fourth lower J-hook is proximal to the second handle second end and a curved portion of the fourth lower J-hook is distal from the second handle second end; and
means for removably connecting the second hand tool to the cooking appliance; and
two or more openings formed in the cooking surface at the second cooking surface side, said two or more openings each forming an engagement shoulder,
wherein the third lower J-hook and the fourth lower J-hook are configured to removably engage the engagement shoulders of the two or more openings formed in the cooking surface at the second cooking surface side.

10. The cooking appliance tool and cooking surface set of claim 8, further comprising:
a back plate fastened to the first upper handle, wherein the back plate covers an upper end of the first lower J-hook elongated straight portion, and the back plate covers an upper end of the second lower J-hook elongated straight portion.

11. The cooking appliance tool and cooking surface set of claim 10, wherein the means for removably connecting the first hand tool to the cooking appliance includes first and second spaced connection pins that each include an outer head portion and an inner neck portion wherein the neck portion is narrower than the head portion.

12. The cooking appliance tool and cooking surface set of claim 11, wherein the connection pins include internal portions that form first and second pegs that extend through the back plate towards the first upper handle, and
wherein the first and second pegs are configured to receive mating openings formed in the elongated straight portions of the first and second lower J-hooks.

13. An outdoor cooking appliance, comprising:
a head unit;
a removable cooking surface having a first side and a second side disposed at opposite ends of the cooking surface;
at least a first opening provided in the cooking surface at the first side;
at least a second opening provided in the cooking surface at the second side;
a first side table extending from the head unit;
a second side table extending from the head unit;
a first tool removably mounted to the first side table, said first tool including:
a first handle configured to be grasped by a first human being hand;
a first J-hook connected to the first handle; and
means for removably connecting the first tool to the first side table; and
a second tool removably mounted to the second side table including:
a second handle configured to be grasped by a second human being hand;
a second J-hook connected to the second handle; and
means for removably connecting the second tool to the second side table,
wherein the first J-hook is configured to removably engage the at least first opening provided in the cooking surface, and
wherein the second J-hook is configured to removably engage the at least second opening provided in the cooking surface.

14. The outdoor cooking appliance of claim 13, further comprising:
a third J-hook connected to the first handle; and
a fourth J-hook connected to the second handle.

15. The outdoor cooking appliance of claim 14, further comprising:
at least a third opening provided in the cooking surface at the first side, said third opening spaced from the first opening provided in the cooking surface; and
at least a fourth opening provided in the cooking surface at the second side, said fourth opening spaced from the second opening provided in the cooking surface.

16. The outdoor cooking appliance of claim 13, wherein the first handle has a back surface that is complementary to, and mates with an outer edge surface of the first side table.

17. The outdoor cooking appliance of claim 16, wherein the first handle has a height dimension extending between a lower edge and an upper edge that is no greater than a height dimension extending between a lower edge and an upper edge of the first side table outer edge surface.

18. The outdoor cooking appliance of claim 13, further comprising:
a back plate fastened to the first handle,
wherein the back plate covers an upper end of the first J-hook.

19. The outdoor cooking appliance tool of claim 18, wherein the means for removably connecting the first tool to the first side table includes first and second spaced connection pins that each include an outer head portion and an inner neck portion wherein the neck portion is narrower than the head portion.

20. The cooking appliance tool of claim 19, wherein the connection pins include internal portions that form first and second pegs that extend through the back plate towards the first handle, and
wherein the first and second pegs are configured to receive mating openings formed in the elongated straight portions of the first and second J-hooks.
